(19) United States
(12) Patent Application Publication
(10) Pub. No.: US 2024/0426080 A1
(43) Pub. Date: Dec. 26, 2024

(54) MODULE

(71) Applicant: PEARSON ENGINEERING LIMITED, Tyne and Wear (GB)

(72) Inventor: James SIMPSON, Tyne and Wear (GB)

(21) Appl. No.: 18/294,812

(22) PCT Filed: Aug. 5, 2022
(86) PCT No.: PCT/EP2022/072169

§ 371 Date: Feb. 2, 2024

(30) Foreign Application Priority Data
Aug. 5, 2021 (GB) 2111345.1

(51) Int. Cl. E02F 9/20; E02F 3/76; E02F 3/96

(52) U.S. Cl. CPC E02F 9/205; E02F 3/7618; E02F 3/968

(57) ABSTRACT

An interchangeable mission module for unmanned ground vehicles is provided. Also provided is a mission module in combination with an unmanned ground vehicle. Also provided are methods and mechanisms for docking and undocking modules and unmanned ground vehicles.

The present invention relates generally to unmanned ground vehicles and particularly, although not exclusively, to an interchangeable mission module for an unmanned ground vehicle (UGV) and to combinations of modules and UGVs, including docking/undocking of such systems.

A UGV is a vehicle that operates while in contact with the ground and without an onboard human presence.

A remote-operated UGV is a vehicle that is controlled by a human operator via interface. Most/all actions are determined by the operator based upon either direct visual observation or remote use of sensors such as digital video cameras.

An autonomous UGV (AUGV) is essentially an autonomous robot that operates without the need for a human controller on the basis of artificial intelligence technologies. The vehicle uses its sensors to develop some limited understanding of the environment, which is then used by control algorithms to determine the next action to take in the context of a human provided mission goal. This eliminates the need for any human to watch over the menial tasks that the AUGV is completing.

Some embodiments provide or relate to Modular Mission Packs (MMPs).

Some embodiments provide or relate to a field deployed UGV (Unmanned Ground Vehicle) or RCV (Robotic Combat Vehicle) that is able to auto dock with a mission specific MMP.

The MMP (or “module”) may, for example, be able autonomously to secure itself to the UGV, and the UGV will then complete its mission. On completion of the mission, the MMP may be autonomously decoupled from the UGV, allowing the UGV to couple with another MMP to support its next mission profile.

Some aspects provide or relate to an interchangeable mission module for unmanned ground vehicles.

Some aspects and embodiments provide or relate to the provision of capability for a UGV.

An aspect of the present invention provides an interchangeable mission module for an unmanned ground vehicle (UGV).

Some aspects and embodiments provide or relate to an interchangeable, self-contained pack.

Some aspects and embodiments provide or relate to multi-mission modules.

Some aspects and embodiments provide or relate to the capacity for interchangeability of equipment of UGVs.

Some aspects and embodiments provide or relate to a dock and/or interface between a UGV and equipment.

A system may be remote and/or fully autonomous. For example docking/undocking may be remote and/or autonomous.

Some aspects and embodiments include at least a component of remote operation. Some aspect and embodiments are or can be configured/used so as to be fully remote. Other aspects and embodiments can or do have at least a component of non-autonomous and/or non-remote operation.

Some aspects and embodiments provide or relate to a flat-top UGV.

Some embodiments provide or relate to a tool-less UGV.

Some aspects and embodiments provide or relate to means for connecting/attaching/associating a module with a UGV.

Some aspects and embodiments provide or relate to the addition/connection or tools onto a module and/or the addition/connection or a module onto a vehicle.

Some aspects and embodiments provide or relate to remote control vehicle dock.

Some aspects and embodiments provide or relate to a modular mission pack dock.

In some embodiments a UGV is or can be driven in or up to a module for connection/association therewith.

There are a range of docking options between UGVs and MMPs. For example manually operated options through to fully autonomous options.

UGV to MMP docking and undocking options may be provided for, ranging from manual to fully autonomous.

Some aspects and embodiments provide or relate to docking/undocking with a vehicle and/or mission module in different states of operation.

### Options:

healthy vehicle: healthy module
unhealthy vehicle: healthy module
healthy vehicle: unhealthy module
unhealthy vehicle: unhealthy module

Some embodiments, for example, allow for a healthy vehicle to free itself from an unhealthy tool and then pick up a new, healthy tool.

The system may include the capability for a functional UGV to jettison a non-functional MMP, and a functional MMP to remove itself from a non-functional UGV.

A UGV: module system may be configured so that either component can cause/initiation release from the other. A mechanical connection arrangement may be used.

To facilitate the undocking process in the event that either UGV or mission module are failed/unhealthy the mechanical locking system may be enabled from both UGV and mission module.

The system may include the ability to release from UGV or mission module without the loss of components from either, thus allowing the healthy module or vehicle to immediately partner without the need for external input to reinstate the jettisoned components.

Both mission module and UGV may, for example, be fitted with actuated locking surfaces that lock both components together.

The locking surfaces may provide guiding to align the mission module with the UGV.

The mission module and UGV may be locked together using one or more of the locking surfaces.

Some embodiments provide a docking mechanism that comprises multiple surfaces on two discreet components that provides a mechanical connection that is releasable from either side of the connection. In some embodiments the mechanism can be engaged or disengaged by actuators.

In some embodiments no reconfiguration or repair is required prior to re-engaging in a future connection.

The module may comprise attachment means for releasably connection to a UGV.

The attachment means may, for example, comprise a twist lock (or part thereof). In some embodiments, for example, the module provides a male component of a twist lock configured for engagement with a female component on a UGV.

The module may be a detachable, self-contained unit.

Power may be provided on or by a UGV and/or on or by a mission module.

Some embodiments make use of one or more actuators and one or more controllers, for example a hydraulic cylinder and a hydraulic valve.

Hydraulic power systems and hydraulic cylinders may be provided. These are examples of the power source and actuator, but alternatives could be used e.g. pneumatic and/or electric base systems.

The module may, for example, further comprise an onboard power pack.

The module may comprise a sideways offset arm.

The module may comprise a load bed or cargo area.

The module may comprise a blade, for example an obstacle clearing blade.

The blade may have a curved profile.

In some embodiment the top edge of a blade is generally vertically above a bottom edge.

The blade may be formed in a V-configuration.

In some embodiments the blade is connected so as to form a low side real hitch point.

The blade may be movable between a lowered, operating position and a raised, stowed position. The blade may also be movable to an intermediate position.

When the blade is in a stowed, operating or intermediate position it may provide protection for the equipment.

Low side real hitch point (RHP) like conventional dozer, unlike normal PEL FEE or other palletised items, high blade stow position provides protection, close to the vehicle, which minimises mobility issues.

In some embodiments one or more rear skids are provided for preventing sub-surface work.

The module may comprise a wire cutter.

The module may comprise an arm, such as a manipulator arm, an excavation arm or an interrogation arm.

In some embodiments corner jacks are provided for raising and lowering the module.

The module may be self-contained/self-sufficient.

The present invention also provides a module as described herein in combination with a UGV.

Some aspects and embodiments provide or relate to an obstacle clearance modular mission pack for integration with UGVs.

Different aspects and embodiments of the invention may be used separately or together.

Further particular and preferred aspects of the present invention are set out in the accompanying independent and dependent claims. Features of the dependent claims may be combined with the features of the independent claims as appropriate, and in combinations other than those explicitly set out in the claims.

The present invention is more particularly shown and described, by way of example, in the accompanying drawings.

The example embodiments are described in sufficient detail to enable those of ordinary skill in the art to embody and implement the systems and processes herein described. It is important to understand that embodiments can be provided in many alternative forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

Unless otherwise defined, all terms (including technical and scientific terms) used herein are to be interpreted as is customary in the art. It will be further understood that terms in common usage should also be interpreted as is customary in the relevant art and not in an idealised or overly formal sense unless expressly so defined herein.

In the description, all orientational terms, such as upper, lower, radially and axially, are used in relation to the drawings and should not be interpreted as limiting on the invention.

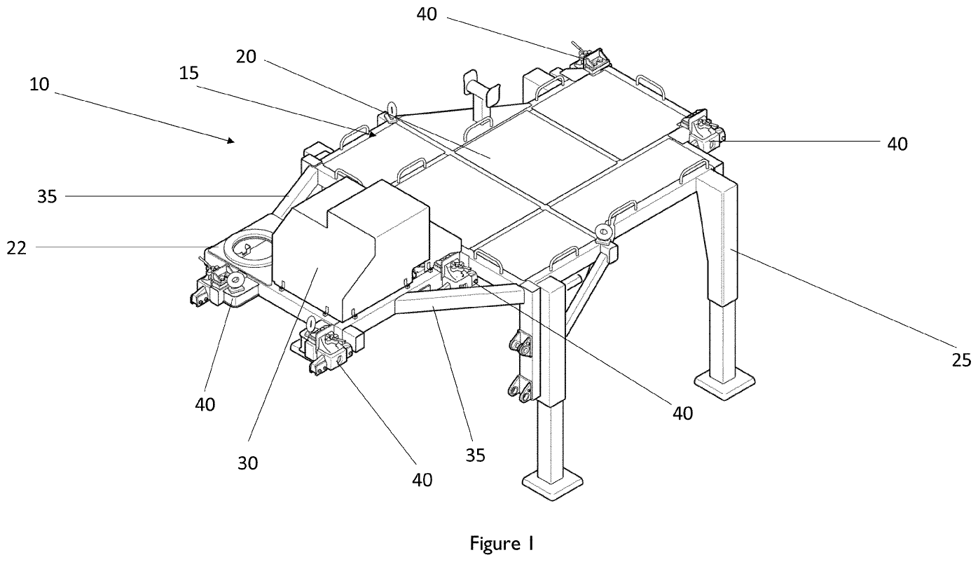

FIG. 1 shows an interchangeable mission module generally indicated 10.

The module 10 comprises a loading bay 15. The loading bay 15 comprises a main deck 20 and a frontal extension 22.

At the corners of the main deck 20 four depending jacks 25 are provided.

The frontal extension 25 supports an onboard power pack 30. Braces 35 extend between the extension 25 and the deck 20.

The rear of the deck 20 is provided with male components of twist locks 40. The front of the deck 20 is also provided with twist lock 40. The front of the extension 25 is also provided with twist locks 40.

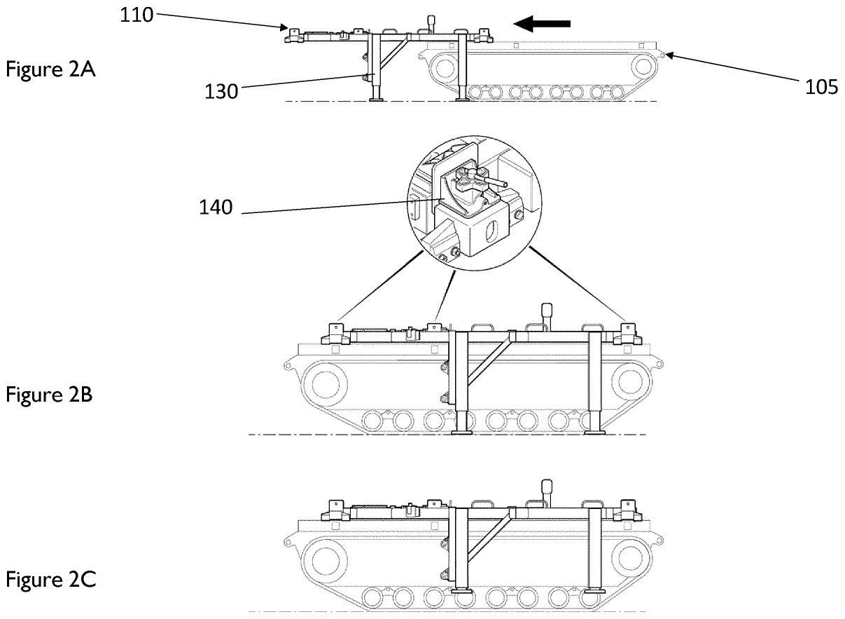

Referring now to FIGS. 2A to 2C a module 110 of a similar type to that described in relation to FIG. 1 is shown.

The module 110 is shown in a raised, ready position in FIG. 2A with jacks 130 deployed. This means that a UGV 105 can be moved under the module.

When in position the module is lowered so that the twist locks 140 can be engaged with corresponding female twist lock components on the UGV, as shown in FIG. 2B. In other embodiments (not shown) the locks do not require lowering for engagement.

The jacks 130 can now be retracted (FIG. 2C) so that the UGV can move off.

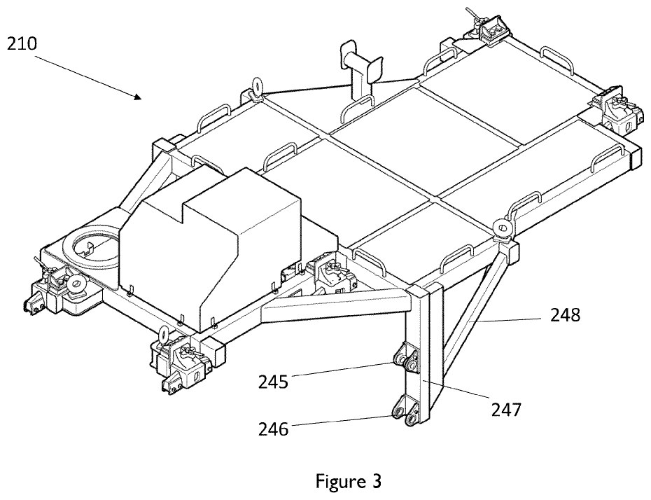

FIG. 3 shows a module 210 formed according to a further embodiment. The module 210 is similar to the module 10.

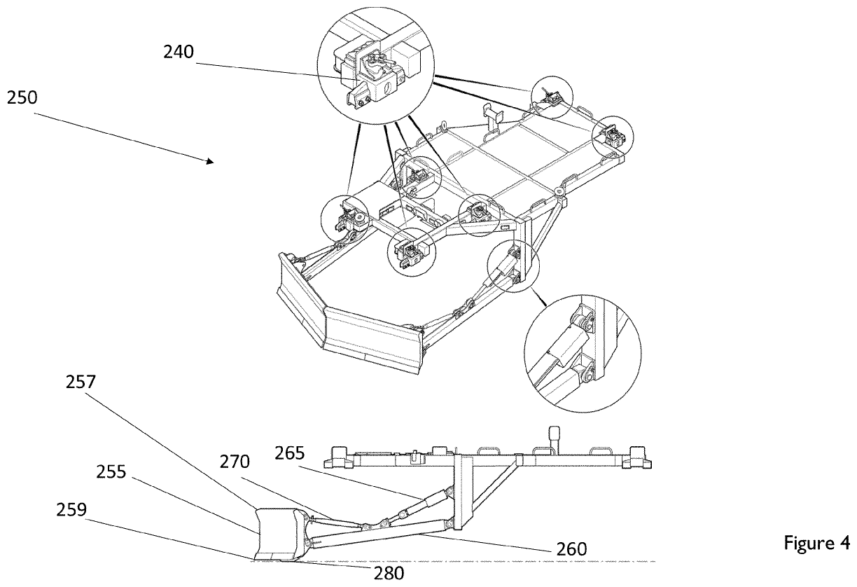

In this embodiment a low side real hitch point 246 and an upper cylinder attachment point 245 are provided on a depending leg 247; a brace 248 extends from the deck 220 to the leg 247. This allows attachment of a blade assembly 250 including a blade 255, a lower boom 260, a cylinder 265 and a turn buckle 270, as shown in FIG. 4. The boom 260 connects to the hitch point 246 and the back of the blade 255. The cylinder 265 connects to the point 245 and then to the boom 260 (approximately half way along). The turn buckle 270 connects to the boom 260 (also approximately half way along) and to the back of the blade 255. The cylinder 265 can lower and raise the blade 255; the turn buckle 270 can adjust the pitch of blade (e.g. to achieve alignment of the top and bottom of the blade).

The low hitch point allows for a high blade stow position-see FIG. 4a. This can be used to provide protection from enemy fire, close to the UGV (the blade can be positioned adjacent the front of the UGV) and minimises mobility issues.

In this embodiment the blade is configured so that it does not go below ground (rear skids 280 may be provided to prevent sub surface work).

The top edge 257 of the blade 255 is substantially vertically above the bottom edge 259 when in use to clear obstacles i.e. the top and bottom edges can simultaneously engage the obstacle.

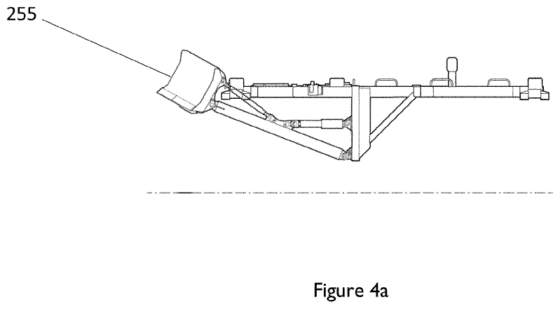

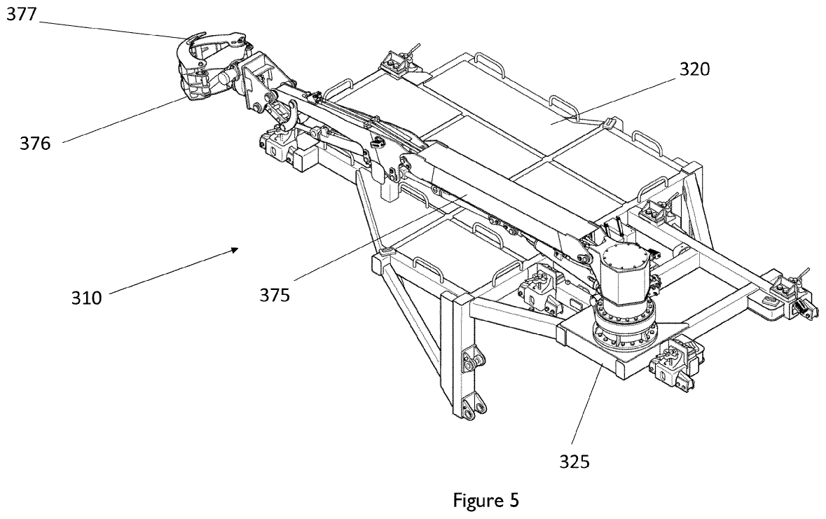

FIG. 5 shows a module 310 formed according to a further embodiment. In this embodiment a sideways offset arm 375 with a grapple 376 is mounted on a frontal portion 325. UGV chassis tend to be strong down the side, so mounting the arm 375 in an offset position (rather than in the middle) of the module is advantageous. In addition this leaves the majority of the load/cargo bed 320 available. In this embodiment the grapple 376 includes a wire cutter 377.

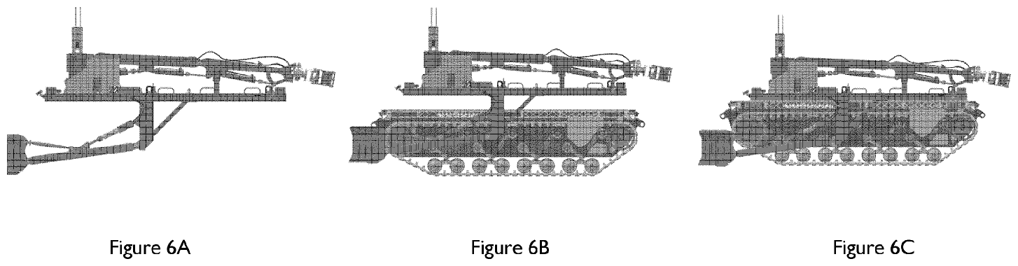

FIGS. 6A to 6C show a module mission pack 410 and a flat-top UGV 490 as the pack (FIG. 6A) is presented to (FIG. 6B) and docked (FIG. 6C) with the UGV.

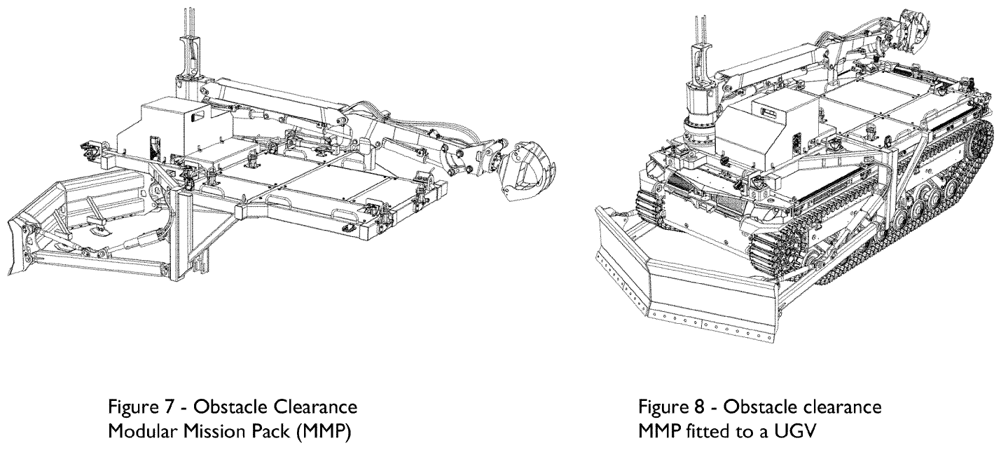

FIG. 7 shows an obstacle clearance MMP 510 and FIG. 8 shows the MMP 510 fitted to a UGV 690. In this embodiment this system is provides as an interchangeable mission module for unmanned ground vehicles.

There are a range of docking options between the UGV and the MMP. For example manually operated options through to fully autonomous options.

The system may include the capability for a functional UGV to jettison a non-functional MMP, and a functional MMP to remove itself from a non-functional UGV.

UGV to MMP docking and undocking options, ranging from manual to fully autonomous are described further below.

Non-limiting options for manual docking and undocking of MMPs and UGVs are discussed. This involves, for example, the docking and undocking of an MMP, to and from a UGV, with dismounted soldiers or other persons performing functions in-situ.

Docking—Stage 1 (Lowering of the MMP onto the UGV)

In one embodiment the manual docking operation comprises the following stages:
The UGV drives into position under the MMP.
Electrical connectors between with the UGV and MMP are manually connected.

Note that it may be possible for this step to be performed later if onboard energy storage and/or manual jacks are used to lower the MMP.
The MMP is lowered onto the UGV using, for example, hydraulics, manually operated jacks, or a combination of the two.
The MMP mechanical interface locks to the UGV are manually engaged.
If used, jacks are moved from their deployed positions to their stowed position on the MMP for later use.

The manual undocking operation comprises the following stages:
Any jacks are moved from their stowed positions to their deployed positions on the MMP.
The MMP mechanical interface locks to the UGV are manually disengaged.
The MMP is raised above the UGV using, for example, hydraulics, manually operated jacks, or a combination of the two.
The electrical connections between with the UGV and MMP are manually disconnected. Note that it may be possible for this step to be performed earlier if onboard energy storage and/or manual jacks are used to raise the MMP.
The UGV reverses out from under the MMP.

Prior to lowering the MMP, the UGV would be positioned under the MMP within a required positional tolerance to allow for successful mating of the mechanical interface.

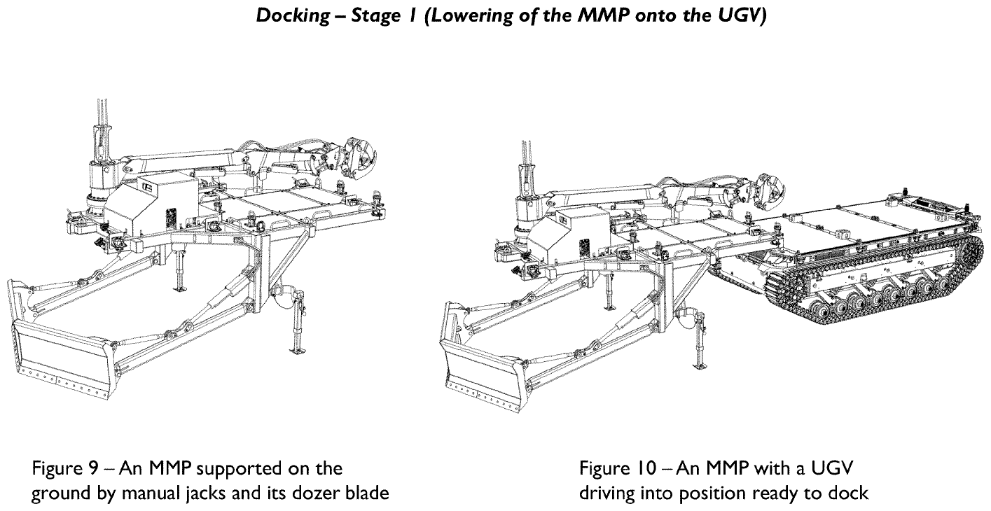

FIG. 9—An MMP supported on the ground by manual jacks and its dozer blade.

FIG. 10—An MMP with a UGV driving into position ready to dock.

The MMP's actuation system (e.g. hydraulic system) may either be powered by energy stored onboard the MMP, or an electrical connection to the UGV might be manually made to power the MMP's hydraulic system. Alternatively, some MMPs may not require hydraulic power at this stage if the MMP design uses only manual jacks for lowering.

Once the hydraulic and control systems of the MMP are powered up, hydraulic valves on the MMP would actuate to command hydraulic cylinders to move, causing the MMP to be lowered. Alternatively manual jacks may be used either exclusively or in tandem with hydraulics to lower the MMP.

If manual jacks are used in some but not all positions, then the manual jacks should be operated to lower the MMP, and the hydraulic cylinders supporting the MMP at other locations should move at a rate to keep the MMP level. This can be achieved either by feedback from inclinometers controlling the rate of the hydraulic decent, or by a manual operator controlling the rate of hydraulic descent.

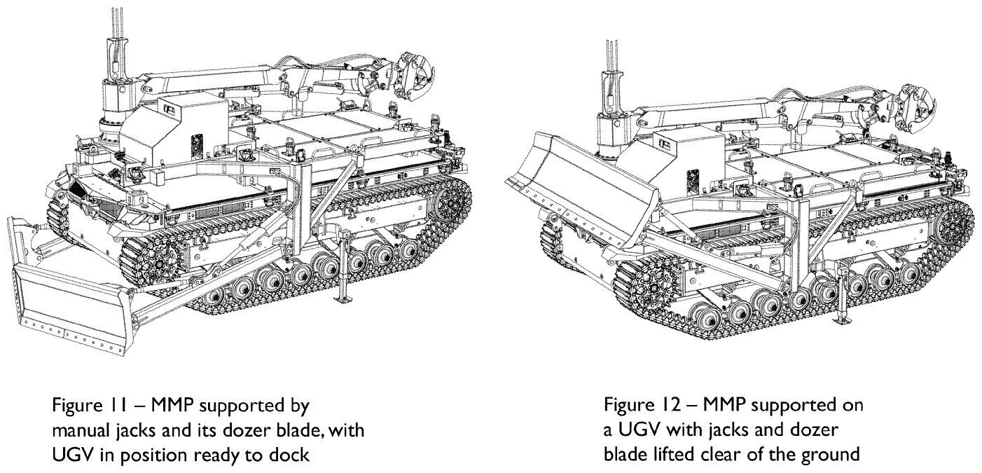

One or more of the hydraulic cylinders used to lower the MMP may be part of ground engaging equipment. For example, the hydraulic cylinders used to lower the MMP in FIG. 11 form part of a V-dozer blade assembly. The hydraulic cylinders may also be part of jack assemblies which have the sole purpose of raising and lowering the MMP.

The MMP should be lowered at a controlled rate and at an appropriate angle relative to the ground to allow for successful docking with the UGV.

Once the whole weight of the MMP is supported on the UGV, any manual jacks should be fully retracted and any hydraulically actuated supports should be lifted clear of the ground, as shown in FIG. 12.

Any jacks should be moved from their deployed positions to their stowed positions on the MMP for later use.

### Docking—Stage 2 (Mechanical and Electrical Connection Between the MMP and UGV)

Mechanical connections, strong enough to carry the loads generated during a mission, are to be made between the MMP and UGV in multiple locations. Mechanical mounting features on the deck of the UGV will be mated with corresponding features on the MMP.

The mechanical connections may be made by manually operated quarter turn twist locks, by pins manually inserted into bores, by hooks, turnbuckles, and/or chains.

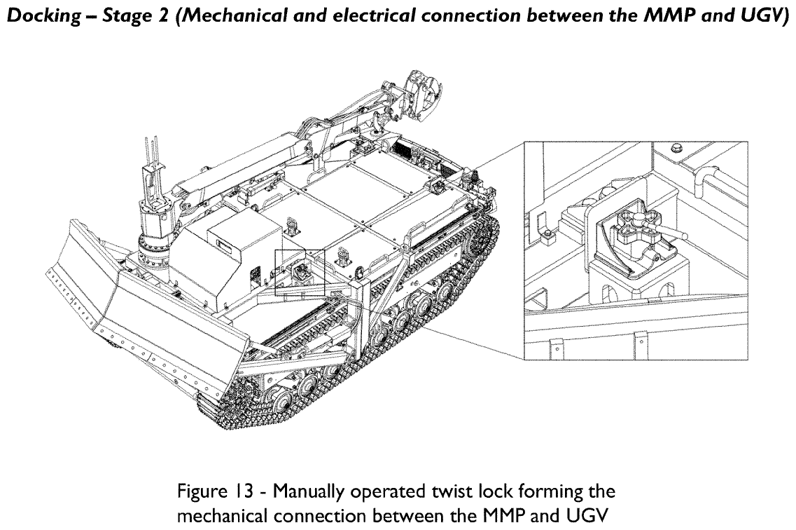

FIG. 13—Manually operated twist lock forming the mechanical connection between the MMP and UGV.

Electrical connections between the UGV would be made by manually mating an electrical connector or connectors, possibly at a bulkhead plate for convenience.

### Undocking-Stage 1 (Mechanical and Electrical Disconnection Between the MMP and UGV)

The electrical connectors between the MMP and UGV may be manually disconnected if the MMP does not require power from the UGV for it to be raised or may be left connected if it does.

The mechanical connections between the MMP and UGV would be manually disengaged.

### Undocking—Stage 2 (Raising the MMP Clear of the UGV)

If used, manual jacks would be moved from their stowed positions on the MMP to their deployed positions.

The MMP hydraulic system would be powered either by energy stored onboard the MMP, or by an electrical connection to the UGV. Alternatively, some MMPs may not require hydraulic power at this stage if the MMP design uses only manual jacks.

Once the hydraulic and control systems of the MMP are powered up, using either onboard power or power taken from the UGV, hydraulic valves on the MMP would actuate to command hydraulic cylinders to move, causing the MMP to be raised clear of the deck of the UGV. Alternatively manual jacks may be used either exclusively or in tandem with hydraulics to raise the MMP clear of the UGV's deck.

If manual jacks are used in some but not all positions, then the manual jacks may be wound to raise the MMP, and the hydraulic cylinders supporting the MMP at other locations should move at a rate to keep the MMP suitably level. This can be achieved, for example, either by feedback from inclinometers controlling the rate of the hydraulic accent, or by a manual operator controlling the rate of hydraulic accent.

One or more of the hydraulic cylinders used to raise the MMP may be part of ground engaging equipment, such as a dozer blade. The hydraulic cylinders may also be part of jack assemblies which have the sole purpose of raising and lowering the MMP.

The MMP should be raised at a controlled rate and at an appropriate angle relative to the ground to allow for successful undocking with the UGV.

Any remaining electrical connection between the MMP and UGV may be manually disconnected.

The UGV may then be reverse out from under the MMP.

### Fully Autonomous Docking and Undocking of MMPs and UGVs

Autonomous docking and undocking of an MMP to and from a UGV is described, outlining provisions for scenarios for when either component is not fully functional.

The stages involved for each operation and the solutions to the associated technical challenges are outlined, by way of example. The number of stages required may vary depending on the method of providing hydraulic power for actuation of the moving components of MMP; there is no need for an MMP that has on-board energy storage to electrically dock with the UGV. An MMP with onboard energy storage has the advantage of being self-sufficient and the advantage of increasing the range of the UGV by not being a parasitic load on its energy stores.

An autonomous docking operation may comprise the following stages:

The UGV autonomously drives under the MMP.

The MMP lowers itself onto the UGV and electrically docks (only applicable for MMPs without onboard energy storage).

The MMP docks mechanically with the UGV.

An autonomous undocking operation may comprise the following stages:
The MMP undocks mechanically from the UGV.
The MMP raises itself above the UGV and electrically undocks (only applicable for MMPs without onboard energy storage).
The UGV autonomously reverses out.

The order and actions of each stage may vary depending on the functionality of components in either system. Provisions will be made for the above steps to be performed manually if the system components necessary for automated docking and undocking fail to operate.

Docking—Stage 1 (Autonomous UGV Alignment and Lowering of the MMP onto the UGV)

This stage concerns the UGV autonomously driving under a specific MMP ready for docking. For this to happen, there are several technical aspects involved:

The MMP requires a small amount of continuous power to perform continuous built-in-testing (BIT). This is to ensure that all subcomponents are fit for function and that the MMP is in an operational state. A rechargeable power source (e.g., battery) on board the MMP will provide this power.

The MMP could wirelessly communicate with a UGV to exchange information prior to docking. The MMP would continuously listen (to reduce power consumption rather than transmitting) for a signal to indicate the presence of a UGV. Methods of communication could include:
RF communications
Bluetooth
WiFi
NFC (Near Field Communication)
Infrared communication

For redundancy, at least two concurrent forms of communication could take place to ensure a failsafe mechanism for communication exists.

Once the MMP has received a signal from a UGV, it should respond with a message to indicate its operational state. An additional coloured beacon mounted on the MMP that could be sensed by a UGV could also be incorporated, with the colour identifying the status of the BIT checks (green=pass, red=fail). If the BIT fails, the UGV can reject this MMP and choose to dock with another fully functional MMP.

The UGV should be able to navigate towards the MMP and autonomously drive under it and align itself so that it is directly under the MMP. To aid the autonomous alignment of the UGV with the MMP:

The MMP could feature fiducial markers on posts for the UGV to sense with stereovision.

Surfaces on the MMP could be painted with specular paint to increase the accuracy of laser returns from a LiDAR system mounted on the UGV.

Returns from radars or proximity sensors mounted on each corner of the UGV could be used with a closed loop feedback control loop to align the UGV sufficiently with the MMP.

Feedback from laser curtains mounted face downwards along the perimeter of the MMP could be wirelessly transmitted to the UGV and be used in a closed feedback control loop to align the UGV sufficiently with the MMP.

Once this stage is complete, the UGV would wirelessly communicate with the MMP to indicate that it is ready for the docking phase.

### Docking—Stage 2 (Electrical Connection Between the MMP and UGV)

This stage concerns the MMP lowering itself onto the UGV and docking electrically. The electrical docking aspect only applies for MMPs that are not self-sufficient and have hydraulic systems that require external power from the UGV. For this to happen, there are several technical aspects involved:

The MMP's hydraulic system could be powered by:
Electrical potential energy stored within batteries onboard the MMP
An onboard combustion engine
Electrical power from the UGV
Fluid power from the UGV

Hydraulic valves on the MMP could be actuated to command hydraulic cylinders to move, causing the MMP to be lowered.

Conical posts and/or other mechanical alignment features may be used to guide the MMP into proper alignment with mounting features on the UGV.

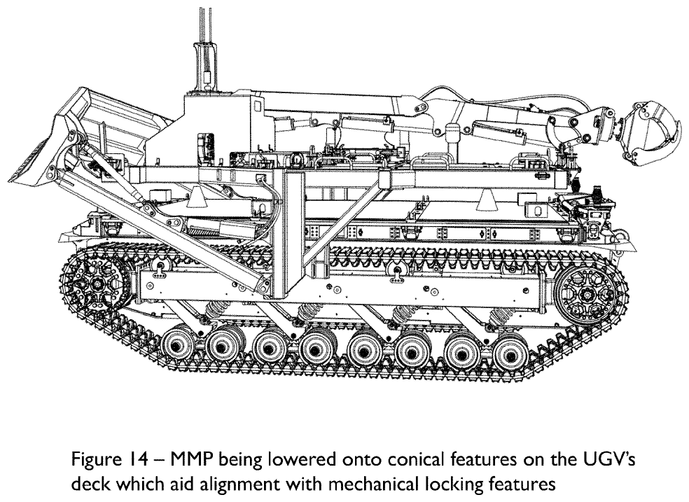

FIG. 14—MMP being lowered onto conical features on the UGV's deck which aid alignment with mechanical locking features.

One or more of the hydraulic cylinders used to lower the MMP may be part of ground engaging equipment, such as a dozer blade. The hydraulic cylinders may also be part of jack assemblies which have the sole purpose of raising or lowering the MMP.

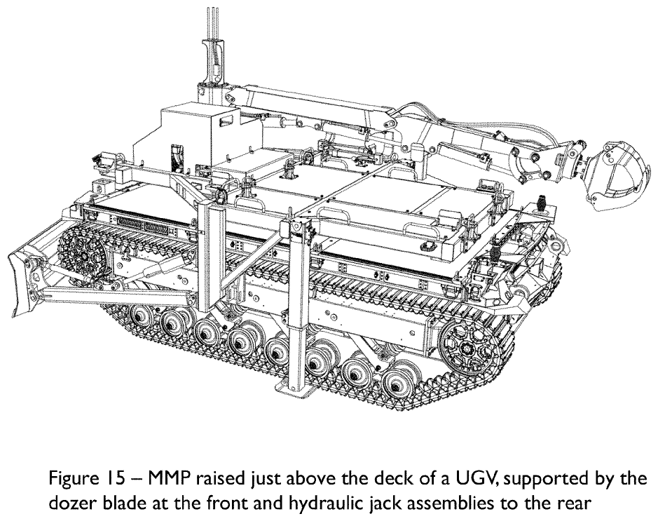

FIG. 15—MMP raised just above the deck of a UGV, supported by the dozer blade at the front and hydraulic jack assemblies to the rear.

The hydraulic cylinders would move at a controlled rate holding the MMP at an appropriate angle relative to the ground to allow for successful docking with the UGV.

Data from rod position indicators in the hydraulic cylinders would be used to control the opening of the hydraulic valves to ensure the MMP is lowered at an appropriate rate and angle.

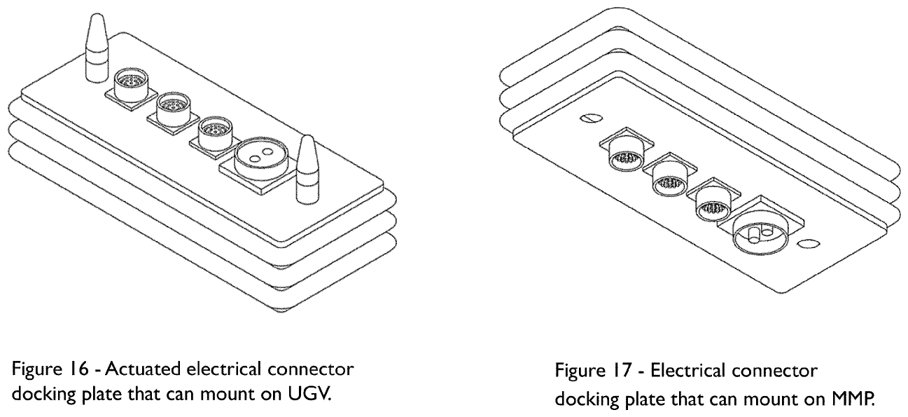

If electrical docking is necessary, a plate with environmentally protected connectors, for example waterproof push-pull connectors, (FIG. 16) could be mounted on the UGV. A fixed plate with mating connectors would be attached on the MMP (FIG. 17).

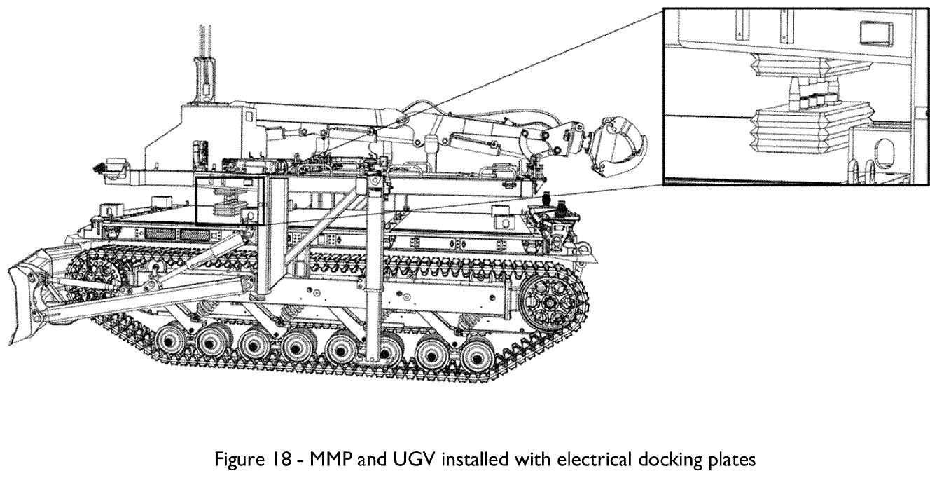

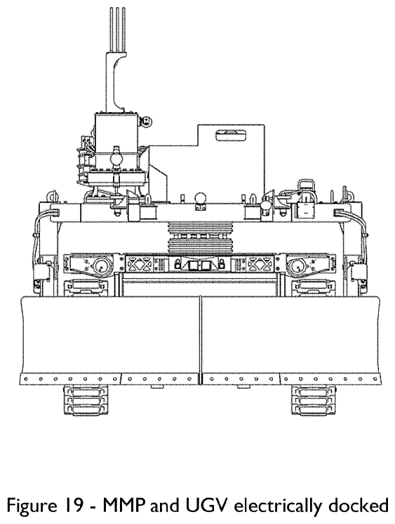

FIG. 18 shows how these plates may look in situ. As the MMP lowers down onto the UGV, the electrical docking plates mate together and electrical connectors are mated through the force of actuation, as shown in FIG. 19.

These plates could feature:
Connectors that could utilise standard plug/socket contacts
Connectors that could utilise spring loaded pogo pins with mating contact pads
Connectors for exchanging fluid power
   Connectors that could facilitate the exchange of multiple electrical signals, including:
      The UGV's electrical power circuit to provide power for the MMP to operate and charge its batteries.
Connection of the MMP to the UGV's communication bus, such as:
Local Area Network (LAN) over Ethernet
CANbus
Serial
Several discrete I/O signals to be shared between the MMP and UGV.
   A flexible rubber housing may be provided to protect the internal components from damage and dust/water ingress.
   During the descent of the MMP, mating of two plates with electrical connectors would also occur.
Probes on the plate would allow for linear misalignment of two plates.
Electromagnets that would aid in alignment and mating/un-mating both plates.
   A flexible base that would allow for lateral and longitudinal movement along a fixed plane account for misalignment.

Once pressure in the hydraulic cylinders has reduced to a value indicating the MMP is entirely supported on the UGV, the jack assemblies or ground engaging equipment previously supporting the MMP would be fully raised. For MMPs that do not require the electrical docking phase, the MMP and UGV would continue to communicate wirelessly throughout the mission and are self-powered, hence no electrical connections are necessary.

### Docking—Stage 3 (Mechanical Connection Between the MMP and UGV)

This stage concerns the MMP docking mechanically with the UGV.

For this to happen, there are several technical aspects involved:

Mechanical connections, strong enough to carry the loads generated during a mission, are made between the MMP and UGV in multiple locations.

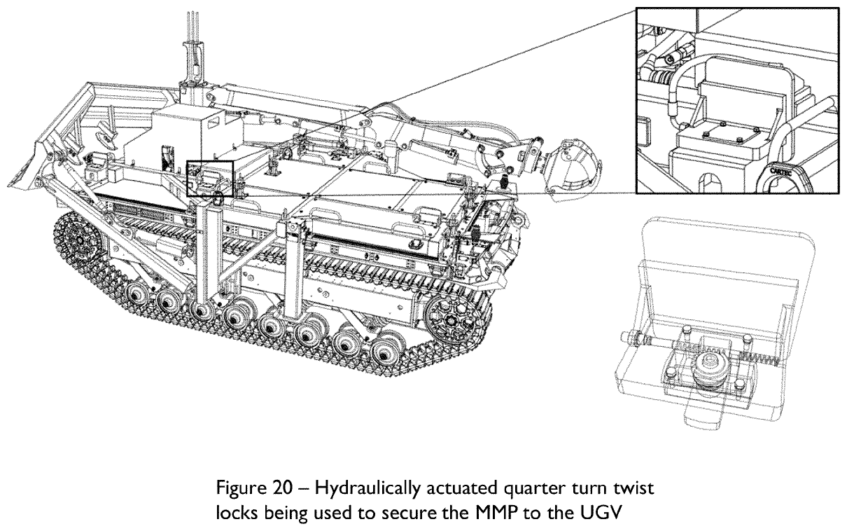

The mechanical connections are made by quarter turn twist locks (FIG. 20), or by pins which are inserted through bores, and are actuated either hydraulically or electrically.

Each mechanical connection point could trigger a switch or other sensor (or multiple switches and sensors) to verify that the mechanical connection between the MMP and UGV has been made successfully.

Undocking-Stage 1 (Mechanical Disconnection of the MMP from the UGV)

This stage concerns the MMP undocking mechanically from the UGV. For this to happen, there are several technical aspects involved:

The UGV would transmit a message to the MMP to signal that it should undock from the UGV.

The UGV would report its BIT status to ensure that all subcomponents are capable of undocking.

The MMP would start its wireless communication mechanism so that it can communicate with the UGV for the duration of the undocking phase.

The mechanical connections between the MMP and UGV would be released to mechanically unlock the MMP from the UGV. Sensors or switches mounted on the MMP could be used to confirm that the mechanical locks have been fully released.

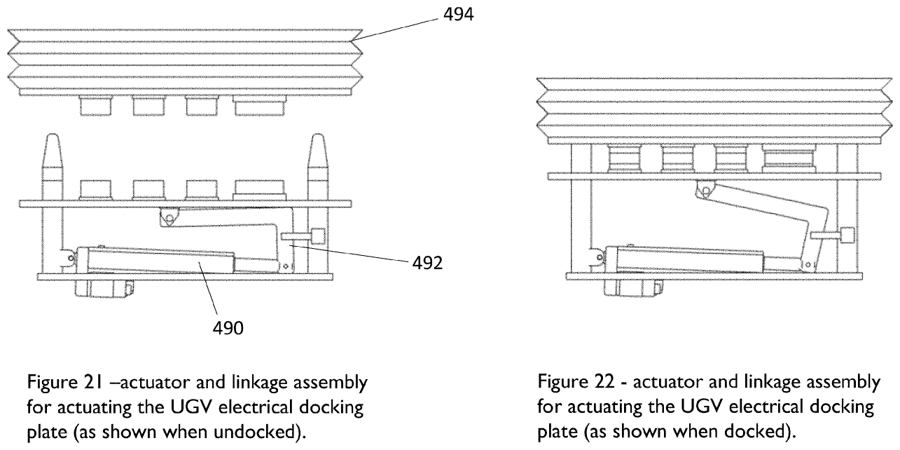

FIG. 21—actuator 490 and linkage 492 assembly for actuating the UGV electrical docking plate 494 (as shown when undocked).

FIG. 22—actuator and linkage assembly for actuating the UGV electrical docking plate (as shown when docked).

### Undocking—Stage 2 (Raising the MMP Clear of the UGV and Disconnecting Electrically)

This stage concerns the MMP raising itself off the UGV and undocking electrically. For this to happen, there are several technical aspects involved:

The UGV or MMP would scan the terrain of the ground surrounding the UGV using a technology such as LiDAR, stereovision, or radar.

If the ground surrounding the UGV is found to have been unsuitable to lift the MMP clear of the UGV, the MMP would need to transmit a signal to the UGV instructing it to navigate to an area with suitable ground before attempting to undock again.

The MMP hydraulic system would be powered by energy stored onboard the MMP.

Hydraulic valves on the MMP would be actuated to command hydraulic cylinders to move, causing the MMP to raise clear of the UGV.

As the MMP rises, the currently mated connector plates would separate, disconnecting the electrical signals.

One or more of the hydraulic cylinders used to lift the MMP may be part of ground engaging equipment, such as a dozer blade. Hydraulic cylinders may be part of jack assemblies having the sole purpose of raising the MMP.

The hydraulic cylinders would move at a controlled rate holding the MMP at an appropriate angle relative to the ground to allow for successful undocking with the UGV.

Data from rod position indicators in the hydraulic cylinders may be used to control the opening of the hydraulic valves to ensure the MMP is raised at an appropriate rate and angle.

Once the MMP had been raised to the full stroke of the hydraulic cylinders lifting it, the MMP would confirm using sensors that it had been lifted far enough clear of the UGV for the UGV to reverse out.

Undocking-Stage 3 (UGV reversing out from MMP)

This stage concerns the UGV reversing out of the MMP to continue its mission. For this to happen, there are several technical aspects involved:
The MMP would transmit a message to the UGV to indicate that it is completely undocked and that the UGV can reverse out.

The UGV is then free to continue its mission.

### Undocking—Functioning UGV Undocking a Non-Functioning MMP

This stage concerns the UGV undocking mechanically, raising the MMP, and undocking itself electrically from the MMP when the MMP is not fully functional. For this to happen, there are several technical aspects involved:

If the MMP is non-responsive (BIT status fail), the UGV could use its electrical link to the MMP to power the main or a reversionary hydraulic pump on the MMP. The UGV could actuate a valve on the MMP which would enable flow through a reversionary hydraulic circuit capable of sequentially unlocking the mechanical locks (e.g., hydraulically actuated quarter turn twist locks) to the MMP and then extending the cylinders of jacks and ground engaging equipment on the MMP to lift the MMP clear of the UGV.

The UGV could retract its electrical docking plate using an actuator and a mechanical linkage, as shown in FIG. 2I. This would break the electrical connection and electrically undock both plates.

The UGV would then be undocked from the non-functioning MMP and free to continue its mission.

### Undocking—Functioning MMP on a Non-Functioning UGV

This stage concerns the MMP undocking mechanically, raising itself off the UGV and undocking electrically if the UGV is not fully functional. For this to happen, there are several technical aspects involved:

A nearby healthy UGV could transmit a signal to the MMP that it should undock itself from the non-functioning UGV it is currently mounted on.

The MMP hydraulic system would be powered by energy stored onboard the MMP.

The mechanical connections between the MMP and UGV would be released to mechanically unlock the MMP from the UGV. Sensors or switches mounted on the MMP could be used to confirm that the mechanical locks have been fully released.

Hydraulic valves on the MMP would be actuated to command hydraulic cylinders to move, causing the MMP to rise clear of the UGV.

As the MMP rises, the mated connector plates would separate, disconnecting the electrical signals.

The hydraulic cylinders would move at a controlled rate holding the MMP at an appropriate angle relative to the ground to allow for successful undocking with the UGV. Data from rod position indicators in the hydraulic cylinders may be used to control the opening of the hydraulic valves to ensure the MMP is raised at an appropriate rate and angle.

Once the MMP had been raised to the full stroke of the hydraulic cylinders lifting it, the MMP would confirm to the nearby healthy UGV that it is clear.

The healthy UGV should then recover the non-functioning UGV and tow it out from under the MMP.

A healthy UGV can then dock with the MMP.

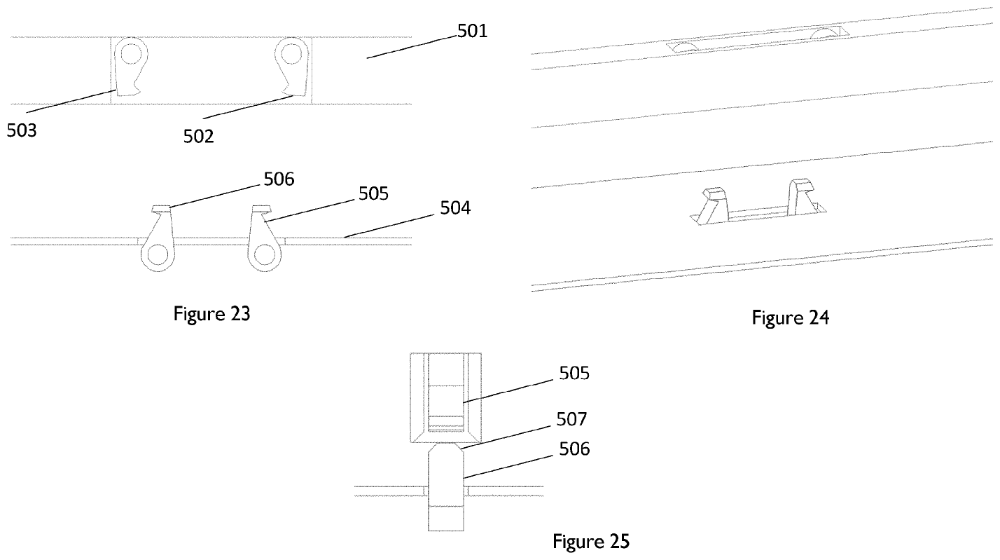

FIGS. 23 to 34 illustrate a mechanical connection/release arrangement for facilitating dock/undocking of a UGV and a mission module.

To facilitate the undocking process in the event that either UGV or mission module are failed/unhealthy, for example, the mechanical locking system needs to be enable from the both UGV and mission module.

The system may include the ability to release from UGV or mission module without the loss of components from either, thus allowing the healthy module or vehicle to immediately partner without the need for external input to reinstate the jettisoned components.

Both mission module and UGV may be fitted with actuated locking surfaces that lock both components together.

The locking surfaces may also provide guiding to align the mission module with the UGV.

The mission module and UGV may be locked together using one or more of these locking surfaces.

FIGS. 23 and 24 show a mission module 501 with a module latch comprising a pair of module latch members 502, 503, and a UGV 504 with a UGV latch comprising a pair of vehicle latch members 505, 506.

In some embodiments a UGV loading deck would be fitted a with a number of these locking devices around the deck, depending on the size of the mission module and the magnitude of the load needed to be transferred. The mission module would be fitting with an opposing pair of latches that globally align with the opposite pair installed on the UGV.

The module is shown above the UGV ready to be lowered. The latch members on the UGV are in a locked position and present a guiding surface to align the mission module as it is lowered. In this embodiment the UGV latch members include a chamfer 507 to guide UGV to mission module engagement during docking-FIG. 25.

The two latch members on the UGV may be synchronised or independently actuated.

The UGV latches may be stowed to leave the UGV loading deck clear from obstructions.

The latch members on the mission module are in the retracted position in preparation for mating the two halves as it is lowered.

The two latch members on the mission module may be synchronised or independently actuated.

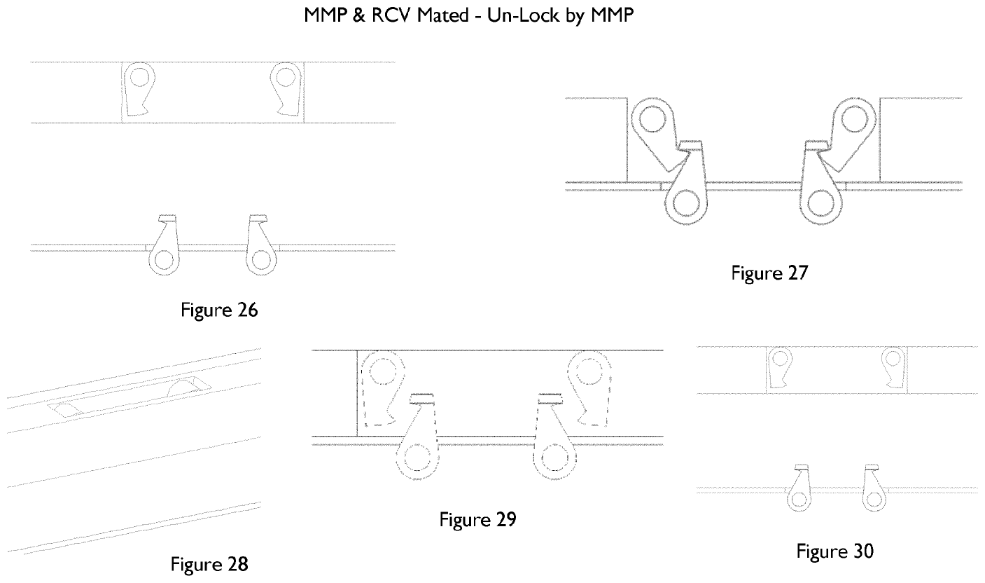

A starting position is shown in FIG. 26, with module latch members shown in a retracted position and vehicle latch members in an engaged position. Once lowered the mission module latch members are actuated to their engaged position and make contact with the UGV latch members to lock the mission module and UGV together-FIGS. 27 and 28.

In the event that the UGV fails the mission module can operate its own latch members (and jacking mechanisms) to disengage from the UGV (even though the vehicle members are in their engaged position)—FIG. 28—and then be jacked clear of the UGV—FIG. 30. The UGV can then be recovered from beneath the mission module using appropriate recovery techniques.

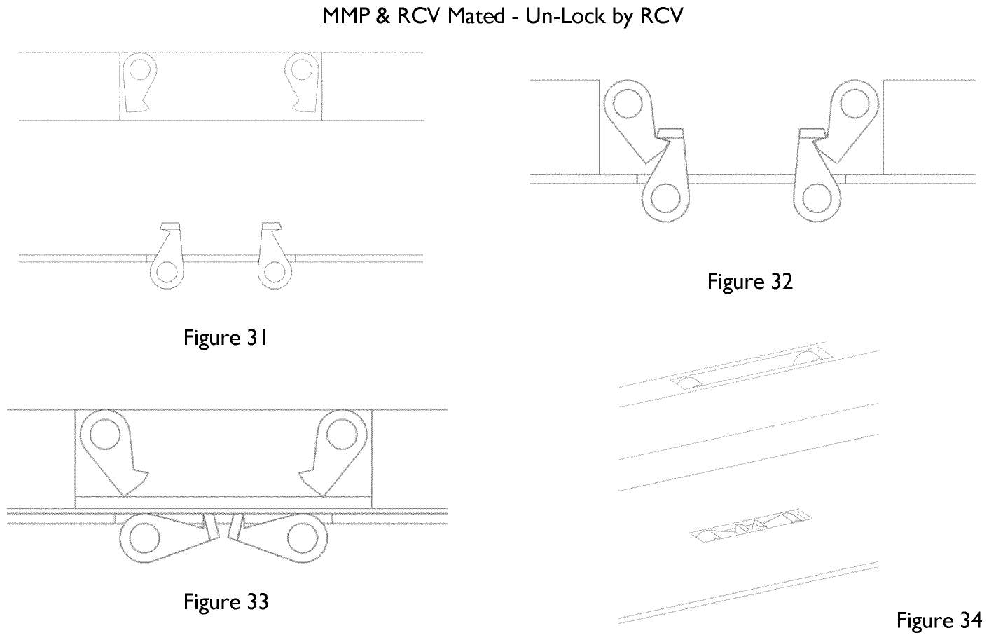

FIG. 31 again shows a starting position, with module latch members shown in a retracted position and vehicle match members in an engaged position. Once lowered the mission module latch members are actuated and make contact with the UGV latch members to lock the mission module and UGV together—FIG. 32.

In the event that the mission module fails the UGV can actuate its latch members (even though the module latch members remain in their engaged position), thus releasing the mission module-FIG. 33. When UGV unlocks the UGV surface presents no obstructions (FIG. 34) and allows MMP to slide freely off the UGV, for example.

The mission module is then free to be recovered from the UGV by sliding off the UGV deck using appropriate recovery techniques.

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention as defined by the appended claims and their equivalents.

1-30. (canceled)

31. An interchangeable mission module for an unmanned ground vehicle (UGV).

32. The module of claim 31, further comprising attachment means for releasable connection to a UGV.

33. The module of claim 32, wherein the attachment means comprise a twist lock.

34. The module of claim 31, wherein the module provides a male component of a twist lock configured for engagement with a female component of a twist lock on a UGV.

35. The module of claim 31, further comprising one or more of: an onboard power pack; a sideways offset arm; a load bed or cargo area; rear skids for preventing sub-surface work.

36. The module of claim 31, further comprising a blade.

37. The module of claim 36, wherein the blade has a curved profile.

38. The module of claim 37, wherein a top edge of the blade is generally vertically above a bottom edge.

39. The module of claim 36, wherein the blade is formed as a V-blade.

40. The module of claim 36, wherein the blade is connected so as to form a low side real hitch point.

41. The module of claim 36, wherein the blade is movable between a lowered, operating position and a raised, stowed position.

42. The module of claim 41, wherein the blade is movable to an intermediate position.

43. The module of claim 42, wherein when the blade is the stowed, operating or intermediate position the blade provides protection for the equipment.

44. The module of claim 36, wherein the pitch of the blade is adjustable.

45. The module of claim 31, further comprising jacks for raising and lowering the module.

46. The module of claim 31 in combination with a UGV.

47. The combination of claim 46, configured for non-, semi-, or fully-autonomous docking and/or undocking.

48. The combination of claim 46, configured for non-, semi-, or fully-autonomous operation.

49. The module of claim 31 and configured as an obstacle clearance modular mission pack for integration with a UGV.

50. A UGV-to-module docking mechanism comprising a mechanical inter-connection that is releasable from either side thereof.
